(19) United States
(12) Patent Application Publication
(10) Pub. No.: US 2009/0266143 A1
(43) Pub. Date: Oct. 29, 2009

(54) Separation column for chromatographs

(76) Inventors: Matthias Rebhan, Riemerling (DE); Daniel Sickert, Munchen (DE)

Correspondence Address: STAAS & HALSEY LLP, SUITE 700, 1201 NEW YORK AVENUE, N.W., WASHINGTON, DC, 20005, US

(21) Appl. No.: 11/988,997

(22) PCT Filed: Jul. 5, 2006
(86) PCT No.: PCT/EP2006/063918

§ 371 Date: Jan. 18, 2008

(30) Foreign Application Priority Data
Jul. 18, 2005 (DE) 10 2005 033 459.8

(51) Int. Cl. G01N 30/16

(52) U.S. Cl. 73/23.41; 977/962

(57) ABSTRACT

In a chromatograph, a separation column is disposed between an injection system and a detector. The separation column includes a bundle of capillaries which are formed of carbon nanotubes with a typical diameter of 0.5 nm to 5 nm and may number in the several hundreds.

### CROSS REFERENCE TO RELATED APPLICATIONS

This application is based on and hereby claims priority to German Application No. 10 2005 033 459.8 filed on Jul. 18, 2005, the contents of which are hereby incorporated by reference.

### BACKGROUND

Described below is a separation column which is used in a chromatograph, in particular a gas chromatograph or in liquid chromatographs, for the separation of different components.

Gas chromatography is a separation method for the analysis of compound gases, in the case of which a gas mixture, usually a carrier gas with a gas sample to be analyzed, is conducted via a liquid film or a solid material that is stationary in the chromatograph. The sample interacts with the surface of the liquid film or the solid material. Since the liquid film or the solid material in the chromatograph remains stationary, different relative speeds of the components of the gas mixture flowing through to the stationary phase are obtained, on the basis of which the composition of the sample can be analyzed. In this process, a short analysis time is to be achieved with a high selectivity and a high resolution. Therefore the gas mixture to be analyzed should be separated into its components in the shortest possible time, in which case very small parts of the individual components are also to be detected. The range can be extended by an optimization of the solid phase or the liquid phase used in the chromatographs, within which range different gas components and different concentrations of these components can still be analyzed. In addition the process aims to provide high mechanical stability of the device as well as temperature stability. The mode of operation of a liquid chromatograph is implemented in a corresponding manner.

This type of device, using a gas chromatograph as an example, is depicted as schematic structure here and includes the following components: An injection system for a sample (the gas mixture which has to be analyzed), a carrier gas added for the improvement of the mobility (or carrier liquid in the case of liquid chromatographs), a separation column with the stationary phase (liquid film or solid material) in order to separate the gas components and at the end of the separation column a detector in order to detect the different gas components and their concentrations. In order to achieve a high separation capacity, a length of several meters and very thin capillaries (diameter typically 1 mm), the insides of which are coated, are usually used in the separation column. Because of the interaction of the gas mixture to be analyzed with this coating of the capillaries, the flow rate is reduced to different extents depending on the type of gas components, so that the gas mixture is broken down and separated into its components and can thus be analyzed.

Separation columns used at present have the disadvantage that they consist of fragile materials (for example, glass) and in addition occupy much space. Hence, chromatographs as a rule cannot be manufactured in a very small and compact form. Typical separation columns of capillaries for the gas chromatography consist of a sleeve of quartz glass (fused silica) with a porous internal coating of, for example, polyamide, aluminum oxide, activated charcoal or the like. Depending on the material and the manufacturing method, different properties and efficiencies are achieved. However, the fragile materials used for the capillary columns limit the mechanical stability of these devices, and in addition a comparatively very great length of the capillary columns is necessary.

In the publications of J. Kong et al., “Nanotube Molecular Wires as Chemical Sensors”, in Science, Vol. 287, p. 622 to 625 (2000) and P. G. Collins et al., “Extreme Oxygen Sensitivity of Electronic Properties of Carbon Nanotubes”, in Science, Vol. 287, p. 1801 to 1804 (2000), the results of tests are described which relate to the change in the physical properties, in particular the electrical resistance of single-walled carbon nanotubes, which are exposed to different gases.

In the paper by S. Peng et al., “Carbon Nanotube Chemical and Mechanical Sensors”, to the 3rd International Workshop on Structural Health Monitoring, Stanford University, September 2001, the changes in the physical properties with the adsorption of gas molecules on single-walled carbon nanotubes is likewise described. In addition, a modification of an arrangement consisting of an electrolyte, a dielectric and a semi-conductor is specified, which serves to detect and identify ions in the electrolyte and in which a semiconducting carbon nanotube is arranged in the center of the dielectric.

In the publication of H. Dai, “Nanotube Growth and Characterization”, in M. S. Dresselhaus, G. Dresselhaus, Ph. Avouris (Hg.), “Carbon Nanotubes”, in Topics Appl. Phys., Vol. 80, p. 29 to 53 (2001), methods for the manufacturing of the carbon nanotubes are described, in particular the growth conditions of single-walled carbon nanotubes and the formation of multi-walled carbon nanotubes, which are grouped into and aligned in bundles.

Further methods for the manufacturing of the carbon nanotubes as well as methods by which the carbon nanotubes are brought into different shapes or arrangements, are described in the publications of M. Chhowalla et al., “Growth process conditions of vertically aligned carbon nanotubes using plasma enhanced chemical vapor deposition”, in J. Appl. Phys., Vol. 90, p. 5308 to 5317 (2001), of O. Jost et al., “Rate-Limiting Process in the Formation of Single-Wall Carbon Nanotubes: Pointing the Way to the Nanotube Formation Mechanism”, in J. Phys. Chem. B, Vol. 106, p. 2875 to 2883 (2002), of V. V. Tsukruk et al., “Nanotube Surface Arrays: Weaving, Bending, and Assembling on Patterned Silicon”, in Phys. Rev. Lett., Vol. 92, p. 065502-1 to 065502-4 (2004), and of H. Ko et al., “Combing and Bending of Carbon Nanotube Arrays with Confined Microfluidic Flow on Patterned Surfaces”, in J. Phys. Chem. B, Vol. 108, p. 4385 to 4393 (2004).

### SUMMARY

An aspect is thus to provide a separation column for chromatographs, which on the one hand has a higher mechanical stability and on the other hand can be embodied shorter and more compact than previous separation columns.

The capillaries of the separation column are carbon nanotubes (CNT, carbon nanotubes). Carbon nanotubes have a round cross section with a typical diameter of between 0.5 nm and 5 nm in the case of single-walled carbon nanotubes and up to 100 nm in the case of multi-walled carbon nanotubes, depending on the manufacturing method according to which they were manufactured. The carbon nanotubes can be manufactured in particular in such a way that they are present as bundles preferably numbering several hundred, typically for example 400 carbon nanotubes, with their packing density being very high. The arrangement of the carbon nanotubes as a compact bundle is suitable in the separation column of a chromatograph to be used. The carbon nanotubes are then at least practically aligned in parallel and at the same time the gas mixture to be analyzed can flow through the carbon nanotubes. The carbon nanotubes have a large inside and outside surface, so that the interaction with the gas mixture to be analyzed is sufficiently large to be able to achieve particularly good results of the analysis, even with shorter separation columns.

### BRIEF DESCRIPTION OF THE DRAWINGS

These and other aspects and advantages will become more apparent and more readily appreciated from the following description of the exemplary embodiments, taken in conjunction with the associated drawings of which:

FIG. 1 is a schematic plan view of an exemplary embodiment of the most important components of a chromatograph having carbon nanotubes.

FIG. 2 is a perspective view of an exemplary embodiment of a bundle of capillaries formed from carbon nanotubes.

FIG. 3 is an end view of an exemplary embodiment of an electrically contacted bundle of carbon nanotubes.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

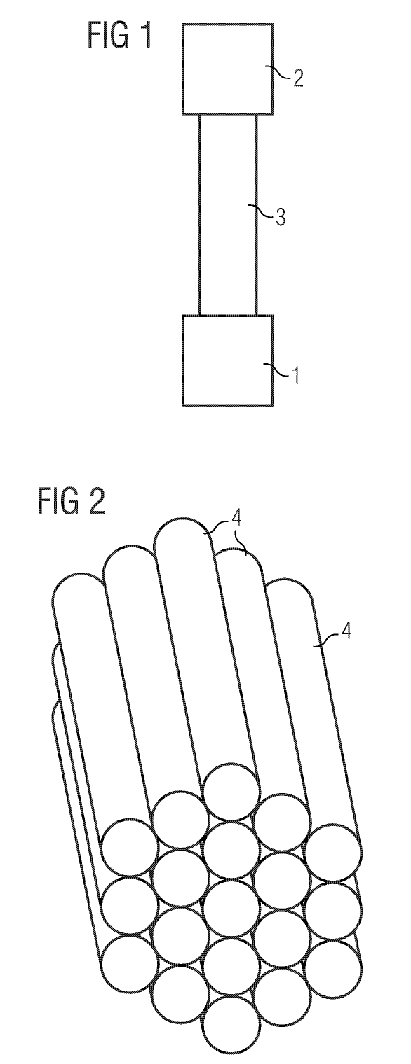

FIG. 1 shows schematically the arrangement of the most important components of a chromatograph. A separation column 3, through which the gas mixture or the liquid mixture flows is arranged between an injection system 1 for a sample and a detector 2 for the analysis of the gas components. The injection system 1 in particular includes intake valves and the like, which are preferably also suitable for mixing a sample to be analyzed with a carrier gas. The separation column 3 includes a bundle of capillaries, formed here from carbon nanotubes and through which the sample to be analyzed flows, with the sample being broken down because of the interaction with the surface of the capillaries into components flowing at different rates. The separated components can then be determined according to their type and concentration in the detector 2. In principle, each detector suitable for chromatographs can also be used here as detector 2.

The surfaces of the carbon nanotubes do not specifically have to be coated. However, it can be of advantage for the interaction of the gas to be analyzed or the liquid to be analyzed with the surface of the carbon nanotubes for the surface to be coated. The carbon nanotubes can for example, according to the type of intercalation, which is known per se, be provided with other elements (for example, alkaline) (for this purpose, for example, the publication of Kong et al., described in the introduction). The carbon nanotubes can be doped with other chemical elements. Individual carbon atoms of the nanotubes can be replaced by foreign atoms, or the foreign atoms are stored between the carbon atoms.

The mixture flowing through the tubes enters into interaction processes (in particular, adsorption and desorption) with the carbon surface. When this occurs, the different components are held back to differing extents and in this way separated from the remaining components. In view of the very small diameters of the carbon nanotubes, a high ratio of the interaction surface to the length of the carbon nanotubes is achieved compared to conventional capillary columns. As a result, the desired fragmentation of the components is achieved with a separation column which is much shorter than the separation columns used at present.

FIG. 2 shows schematically a bundle of capillaries 4, as is used in the separation column, with the length and the diameter of the tubes not being true-to-scale. Instead of only 19 carbon nanotubes as illustrated in the simplified representation of FIG. 2, several hundred carbon nanotubes are preferably used in the separation column. However, it can be seen from FIG. 2 that a hexagonal arrangement of the tube cross sections facilitates a very high packing density, so that a very compact embodiment of the separation column becomes possible.

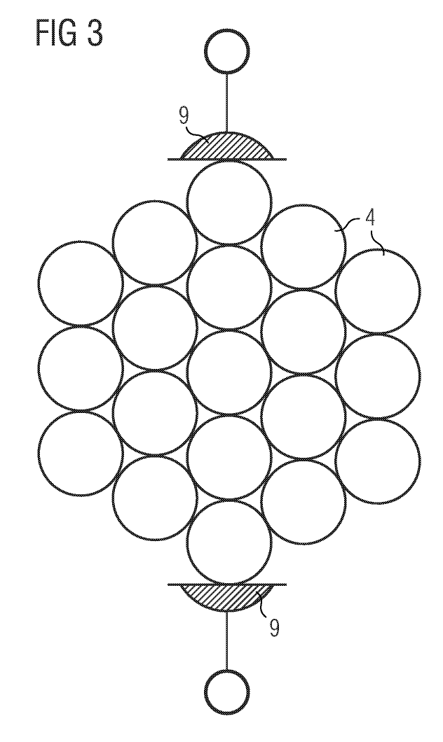

FIG. 3 shows a cross section of a bundle of capillaries 4, which are formed of carbon nanotubes, for a further embodiment, in the case of which the bundle of capillaries is provided with electrical connections 9. The terminals 9 can be implemented in a different way and are only represented schematically in FIG. 4. The significant aspect for this exemplary embodiment is that the electrical properties of the separation column are able to be checked and detected with these electrical terminals. The adsorption processes in the case of a sample that is flowing through the tubes which take place on the surfaces of the carbon nanotubes, thus lead to a change in the electrical properties of the carbon nanotubes, in particular the electron hole mobility in the carbon of the tubes. These changes in the electrical properties can be registered via the electrical terminals and can be used in addition to the data of the detector 2 for the analysis of the sample.

The separation column with bundles of carbon nanotubes has a number of advantages. Carbon nanotubes have a large surface and therefore, even in the case of a smaller length, offer a sufficient interaction with a sample to be analyzed; as a result shorter analysis times than those with conventional separation columns are also achieved. For this reason, the reduced overall dimensions that have been achieved also significantly reduce the costs of producing the columns. Carbon nanotubes have a high chemical resistance, so that applications are possible within greater temperature ranges.

The use of this separation column makes it possible to manufacture chromatographs, in particular gas chromatographs, in a considerably more compact design than previously. As a result, new application areas of the chromatographs are obtained. Due to the increased separation power of the carbon nanotubes, the detection limits are also extended, in particular if, in addition, the electrical properties of the carbon nanotubes of the separation column are registered via electrical terminals and included in the analysis.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-6. (canceled)

7. A separation column for chromatographs having an injection system for a sample, and a detector, comprising:
a bundle of capillaries, formed of carbon nanotubes, between the injection system and the detector and through which the sample flows when in use, the capillaries having one of a surface finish and a surface coating producing different flow rates of different components of the sample within the separation column.

8. The separation column as claimed in claim 7, wherein there are at least 100 of the carbon nanotubes.

9. The separation column as claimed in claim 8, further comprising electrical terminals on said bundle of capillaries, by which electrical properties of the carbon nanotubes, which change when the sample flows therethrough, are detected.

10. The separation column as claimed in claim 9, wherein the carbon nanotubes are coated.

11. The separation column as claimed in claim 9, wherein the carbon nanotubes are provided with an intercalation of at least one chemical element other than carbon.

12. The separation column as claimed in claim 9, wherein the carbon nanotubes are doped with at least one chemical element.
